(19) United States
(12) Patent Application Publication
(10) Pub. No.: US 2023/0319956 A1
(43) Pub. Date: Oct. 5, 2023

(54) Apparatus And Methods For Non-Resonant Microwave Thermal Processing

(71) Applicant: Metallum3D, Inc., Rockville, VA (US)

(72) Inventor: Nelson Zambrana, Rockville, VA (US)

(21) Appl. No.: 18/040,951

(22) PCT Filed: Aug. 18, 2021
(86) PCT No.: PCT/US2021/046469

§ 371 Date: Feb. 7, 2023

Related U.S. Application Data
(60) Provisional application No. 63/067,145, filed on Aug. 18, 2020.
(60) Provisional application No. 63/067,657, filed on Aug. 19, 2020.

(51) Int. Cl. H05B 6/64; H05B 6/70; C04B 35/64

(52) U.S. Cl. CPC H05B 6/6402; H05B 6/708; C04B 35/64; C04B 2235/349; H05B 2206/046; C04B 2235/3826

(57) ABSTRACT

Microwave apparatus and methods provide for non-resonant microwave thermal processing that utilize non-resonant, cross polarized, slotted waveguide arrays in conjunction with a granular susceptor material to homogenously distribute microwave energy inside a microwave cavity, resulting in highly uniform temperature distributions and part heating profiles during processing.

### CROSS REFERENCE TO RELATED APPLICATIONS

This application is a national phase application of PCT Patent Application No. PCT/US2021/046469 filed Aug. 18, 2021, which claims priority to U.S. Provisional Patent Application Ser. No. 63/067,145 filed Aug. 18, 2020, and U.S. Provisional Patent Application Ser. No. 63/067,657 filed Aug. 19, 2020. The entire contents of the foregoing applications are incorporated herein by reference.

### TECHNICAL FIELD

The present application relates to thermal processing of compositions comprising ceramic and/or metal using microwave radiation.

### BACKGROUND

Powder manufacturing of parts made from metal and/or ceramic powders and combinations thereof, describes various processes in which a part is made to a near shape or final shape without the need to use material removing processes, thereby significantly reducing material losses and manufacturing costs. One of the more recent technical developments in this area involves the use of additive manufacturing. In one technique, a 3D printer may extrude a feedstock composed of a metal or ceramic powder and a binder to create a green part, also referred to as a preliminary version of the part, without the need for a mold. The green part may then undergo debinding and sintering processes to produce a solid metal or ceramic part. In another technique, a 3D printed part is produced by selectively spraying a binder into successive layers of a metal or ceramic powder material to form a green part. The green part is then subjected to a sintering process to produce a solid metal or ceramic part. Sintering processes play a major role in metal powder manufacturing and over the last 40 years the performance of conventional sintering processes has not significantly improved. Current conventional sintering processes for metal and ceramic powder manufacturing have slow heating rates (˜5 deg. C/min), long sintering times (>24 hrs.), high energy consumption and high equipment costs.

A more recent and faster method for sintering parts made from powdered particulate uses microwave energy. Microwave sintering of powdered metallic and ceramic materials has been accomplished for several decades and has many advantages over the conventional methods. Some of these advantages include: time and energy saving, very rapid heating rates, considerably reduced processing time, lowered sintering temperature, better microstructures and hence improved mechanical properties, and being more environmentally friendly.

The use of microwave energy can reduce sintering time by a factor of ten or more, which can minimize grain growth. The fine initial microstructure can be retained without using grain growth inhibitors and hence achieve high mechanical strength. The heating rates for a typical microwave process are high and the overall cycle times are reduced by similar amounts as with the process sintering time, including for example, from days to hours.

Despite many advantages, there are two primary problems associated with microwave sintering. The first problem is that microwave sintering systems operating in a multi mode resonant condition suffer from uneven microwave energy distributions due to the standing waves that are generated inside the microwave applicator, which in turn leads to non-uniform heat distributions in the form of hot and cold spots. The second problem is that parts undergoing microwave sintering exhibit volumetric heating resulting in a reverse heating profile where the inside of the part is hotter than the outside of the part. Since heat uniformity is one of the most critical sintering parameters, these two problems have prevented microwave sintering from being used on a large scale commercial basis.

Prior approaches to sintering have failed to address the foregoing problems. For example, U.S. Pat. No. 10,578,361, titled “Microwave Furnace For Thermal Processing,” discloses a microwave assisted furnace system operating in a multi-mode resonant condition, which employs heating elements in conjunction with a microwave delivery system composed of a magnetron, an external waveguide, a microwave port and mode stirring flag. Similarly, PCT patent application publication WO 2018/200515, titled “Sintering Additively Manufactured Parts In Microwave Oven,” describes sintering additively manufactured parts in a microwave oven operating in a multi-mode resonant condition. Neither of the foregoing publications address the previously-described problems associated with resonant microwave conditions.

In another example, Korean Patent No. KR101707921B1, titled “Microwave Heating and Dryer Using Rectangular Waveguide Traveling Wave Antenna,” describes a single traveling waveguide with a bend along its length. The slots in the waveguide are arranged in a progressive slant pattern where the angle varies increasingly in the direction of microwave travel. containing equally spaced slots at equal or unequal tilt angles. This microwave system is suitable for near field microwave heating, but is not suitable for farfield microwave heating.

In yet another example, U.S. Pat. No. 6,583,394, titled “Apparatus and Method for Processing Ceramics,” discloses a microwave heating apparatus for processing ceramics that uses conventional heating in combination with microwave heating. The system distributes microwave energy using branched slotted waveguides. As illustrated in the drawings, the slots of the waveguides are all transverse to the longitudinal axis of the section of waveguide where the slots are positioned. This patent does not address the previously-described problems of the prior art.

### SUMMARY

In one example embodiment, the present disclosure is directed to a microwave apparatus for producing a thermally processed part. The microwave apparatus can comprise a metallic housing, a first microwave energy source positioned to direct first microwave radiation into a first slotted waveguide, and a second microwave energy source positioned to direct second microwave radiation into a second slotted waveguide. The first slotted waveguide can comprise a first major waveguide axis and a plurality of longitudinal slots that emit a first modified microwave radiation, wherein the plurality of longitudinal slots have a length that is parallel to the first major waveguide axis. The second slotted waveguide can comprise a second major waveguide axis and a plurality of transverse slots that emit a second modified microwave radiation, wherein the plurality of transverse slots have a length that is perpendicular to the second major waveguide axis. The foregoing example embodiment can include one or more of the following features.

In one example, the first major waveguide axis can pass through a first longitudinal center of a first radiating surface of the first slotted waveguide, the second major waveguide axis can pass through a second longitudinal center of a second radiating surface of the second slotted waveguide, and the first major waveguide axis and the second major waveguide axis can be parallel. Furthermore, the first major waveguide axis and the second major waveguide axis can be separated by a distance greater than a half wavelength of the first microwave radiation.

In the foregoing microwave apparatus, the first slotted waveguide can have an S11 parameter value less than −20 dB and greater than −40 dB. Furthermore, the first slotted waveguide can have a voltage standing wave ratio parameter value less than 1.5 and greater than 1.

In the foregoing microwave apparatus, for the first slotted waveguide, a graph of the first modified microwave radiation in spherical coordinates at a constant value of Phi=90 can have a maximum deviation of +/−7.5 dBV in a range from 30 degrees to 150 degrees. For the first slotted waveguide, a graph of the first modified microwave radiation in spherical coordinates at a constant value of Theta=90 can have a maximum deviation of +/−7.5 dBV in a range from 30 degrees to 150 degrees.

In the foregoing microwave apparatus, the second slotted waveguide can have an S11 parameter value less than −20 dB and greater than −40 dB. Furthermore, the second slotted waveguide can have a voltage standing wave ratio parameter value less than 1.5 and greater than 1.

In the foregoing microwave apparatus, for the second slotted waveguide, a graph of the second modified microwave radiation in spherical coordinates at a constant value of Phi=90 can have a maximum deviation of +/−7.5 dBV in a range from 30 degrees to 150 degrees. For the second slotted waveguide, a graph of the second modified microwave radiation in spherical coordinates at a constant value of Theta=90 can have a maximum deviation of +/−7.5 dBV in a range from 30 degrees to 150 degrees.

In the foregoing microwave apparatus, for a combined electric field of the first modified microwave radiation and the second modified microwave radiation, a graph in spherical coordinates at a constant value of Phi=90 can have a maximum deviation of +/−7.5 dBV in a range from 30 degrees to 150 degrees. For a combined electric field of the first modified microwave radiation and the second modified microwave radiation, a graph in spherical coordinates at a constant value of Theta=90 can have a maximum deviation of +/−7.5 dBV in a range from 30 degrees to 150 degrees.

In the foregoing microwave apparatus, the first slotted waveguide and the second slotted waveguide can have an S21 parameter value less than −20 dB and greater than −40 dB. Additionally, the first slotted waveguide and the second slotted waveguide can have an S12 parameter value less than −20 dB and greater than −40 dB.

In the foregoing microwave apparatus, the first microwave energy source can be directly coupled to the first slotted waveguide and the second microwave energy source can be directly coupled to the second slotted waveguide.

In the foregoing microwave apparatus, a majority of transverse slots of the plurality of transverse slots can have unique lengths relative to the second major waveguide axis of the second slotted waveguide.

The foregoing microwave apparatus can further comprise a granular susceptor material, the granular susceptor material comprising a ceramic material, a microwave absorbing material, and a susceptor material binder.

In another example embodiment, the present disclosure is directed to a process for thermal processing of particulate material to form a processed part. The process can comprise: creating a preliminary version of a part, the preliminary version of the part comprising the particulate material and a particulate binder; embedding the preliminary version of the part in a granular susceptor material, the granular susceptor material comprising a ceramic material, a microwave absorbing material, and a susceptor material binder; and subjecting the preliminary version of the part submerged in the granular susceptor material to microwave radiation from a microwave apparatus to form the processed part. The microwave apparatus can comprise: a first slotted waveguide comprising a plurality of longitudinal slots and a second slotted waveguide comprising a plurality of transverse slots.

In the foregoing process, a majority of longitudinal slots of the plurality of longitudinal slots can have unique offset distances from a first major waveguide axis of the first slotted waveguide; and a majority of transverse slots of the plurality of transverse slots can have unique lengths relative to a second major waveguide axis of the second slotted waveguide.

The foregoing example embodiments and other example embodiments will be explained in further detail in the follow description.

### BRIEF DESCRIPTION OF THE DRAWINGS

The accompanying drawings illustrate only example embodiments of a microwave apparatus and method and therefore are not to be considered limiting of the scope of this disclosure. The principles illustrated in the example embodiments of the drawings can be applied to alternate microwave apparatus and methods. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 is a schematic view of a microwave cavity configured for use in example embodiments of the present disclosure.

FIGS. 2A and 2B provide schematic views of a non-resonant, cross polarized, slotted waveguide array configured for use in example embodiments of the present disclosure.

FIG. 3 is an image of a three dimensional model of a non-resonant, cross polarized, slotted waveguide array configured for use in example embodiments of the present disclosure.

FIG. 4 is an image of the three dimensional Farfield radiation pattern for the non-resonant, cross polarized, slotted waveguide array used in the example embodiments of the present disclosure.

FIG. 5 is a plot, in spherical coordinates, of the Array Factor showing the Farfield microwave distribution pattern at constant Phi angle of 90 degrees for the non-resonant, cross polarized, slotted waveguide array used in the example embodiments of the present disclosure.

FIG. 6 is a plot, in spherical coordinates, of the Array Factor showing the Farfield microwave distribution pattern at constant Theta angle of 90 degrees for the non-resonant, cross polarized, slotted waveguide array used in the example embodiments of the present disclosure.

FIG. 7 is a plot for the S12 parameter of the non-resonant, cross polarized, slotted waveguide array used in the example embodiments of the present disclosure.

FIG. 8 is a plot for the S21 parameter of the non-resonant, cross polarized, slotted waveguide array used in the example embodiments of the present disclosure.

FIG. 9 is a three dimensional plot of the cross section of the Farfield electric field for the non-resonant, cross polarized, slotted waveguide array used in the example embodiments of the present disclosure.

FIGS. 10A and 10B are schematic views of a non-resonant slotted waveguide with transverse slots configured for use in example embodiments of the present disclosure.

FIG. 11 is the equation used for the calculation of the Farfield resistance of the n-th slot in the non-resonant transverse slotted waveguide of the example embodiment.

FIGS. 12A, 12B, and 12C describe a three dimensional model with tables showing variable values, resistance values, and slot length values for a non-resonant slotted waveguide with transverse slots configured for use in example embodiments of the present disclosure.

FIG. 13 is an image showing the three dimensional Farfield microwave distribution pattern in spherical coordinates for a non-resonant slotted waveguide with transverse slots configured for use in example embodiments of the present disclosure.

FIG. 14 is a plot, in spherical coordinates, of the Array Factor showing the Farfield microwave distribution pattern at constant Phi angle of 90 degrees for a non-resonant slotted waveguide with transverse slots configured for use in example embodiments of the present disclosure.

FIG. 15 is a plot, in spherical coordinates, of the Array Factor showing the Farfield microwave distribution pattern at constant Theta angle of 90 degrees for a non-resonant slotted waveguide with transverse slots configured for use in example embodiments of the present disclosure.

FIG. 16 is a plot of the Voltage Standing Wave Ratio (VSWR) for a non-resonant slotted waveguide with transverse slots configured for use in example embodiments of the present disclosure.

FIGS. 17A and 17B are schematic views of a non-resonant slotted waveguide with longitudinal slots configured for use in example embodiments of the present disclosure.

FIG. 18 is the equation used for the calculation of the Farfield conductance of the n-th slot in the non-resonant longitudinal slotted waveguide of the example embodiment.

FIGS. 19A, 19B, and 19C describe a three dimensional model with tables showing variable values, conductance values, and slot offset values for a non-resonant slotted waveguide with longitudinal slots configured for use in example embodiments of the present disclosure.

FIG. 20 is an image showing the three dimensional Farfield microwave distribution pattern in spherical coordinates for a non-resonant slotted waveguide with longitudinal slots configured for use in example embodiments of the present disclosure.

FIG. 21 is a plot, in spherical coordinates, of the Array Factor showing the Farfield microwave distribution pattern at constant Phi angle of 90 degrees for a non-resonant slotted waveguide with longitudinal slots configured for use in example embodiments of the present disclosure.

FIG. 22 is a plot, in spherical coordinates, of the Array Factor showing the Farfield microwave distribution pattern at constant Theta angle of 90 degrees for a non-resonant slotted waveguide with longitudinal slots configured for use in example embodiments of the present disclosure.

FIG. 23 is a plot of the Voltage Standing Wave Ratio (VSWR) for a non-resonant slotted waveguide with longitudinal slots configured for use in example embodiments of the present disclosure.

FIGS. 24A and 24B show the differences in heating profiles between conventional and microwave sintering.

FIG. 25 shows a photograph the granular susceptor material provided by the example embodiments of the present disclosure.

FIG. 26 shows a heating profile of microwave heating with the granular susceptor material provided by the example embodiments of the present disclosure.

FIG. 27 provides a flow chart of a method for non-resonant microwave thermal processing in accordance with example embodiments of the present disclosure.

### DETAILED DESCRIPTION OF EXAMPLE EMBODIMENTS

The example embodiments described herein are directed to microwave apparatus and methods. The example embodiments described herein can provide one or more advantages that address the problems referenced above. For instance, the example waveguide array embodiments described herein provide a non-resonant microwave emission field that produces a more uniform microwave energy distribution when compared to prior art approaches. The more uniform microwave energy distribution avoids the non-uniformities in heating that occur with standing microwaves in a resonant heating approach. Additionally, the use of a granular susceptor material for embedding the part that is to be sintered contributes to more uniform heating profile for the part. An example embodiment of the present disclosure includes a computer controlled microwave thermal processing apparatus that thermally processes parts made from metallic and/or ceramic powders under a controlled atmosphere with non-resonant, cross polarized, slotted waveguide arrays and a granular susceptor material.

As will be described further in the following examples, the methods and apparatus described herein improve upon prior art approaches to microwave sintering. In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

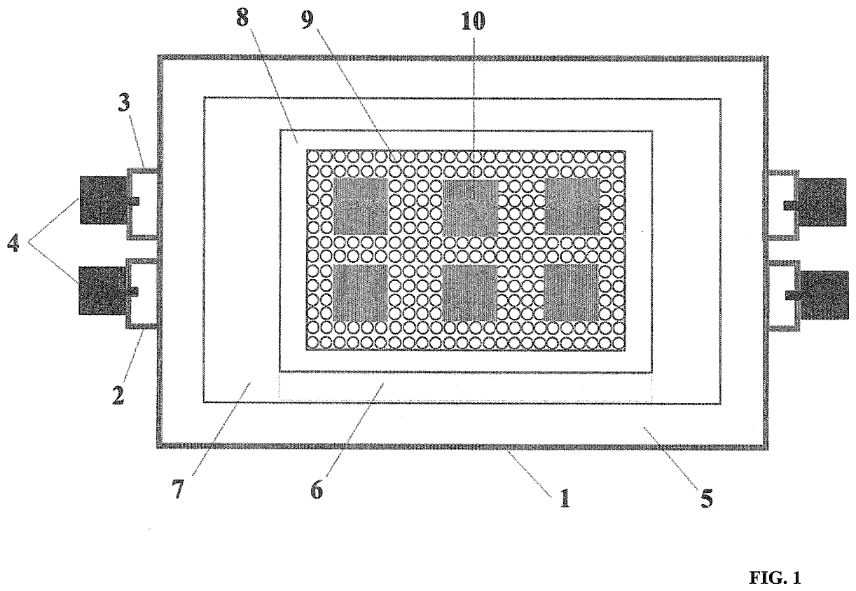

Referring now to FIG. 1, a schematic is provided showing one example embodiment of a microwave apparatus. The embodiment shown includes an outer metallic structure 1 that defines the volume of the microwave cavity which operates in the microwave frequency range from 300 MHz to 300 GHz. Attached to the outer metallic structure 1 is a non-resonant, cross polarized slotted waveguide array composed of a non-resonant slotted waveguide with transverse slots 2 and a non-resonant slotted waveguide with longitudinal slots 3, each of which is attached to the microwave apparatus such that microwave radiation is emitted from the slots into the inner cavity of the microwave apparatus. Each non-resonant, cross polarized slotted waveguide has a magnetron 4, or other microwave energy source, directly mounted to it. The primary function of the non-resonant, cross polarized slotted waveguides in the waveguide array is to homogeneously distribute microwave energy within the microwave cavity volume. The secondary function of the non-resonant slotted waveguides in the waveguide array is to minimize the amount of reflected energy back to the magnetrons 4. The magnetrons 4 are directly mounted on the non-resonant slotted waveguides 2,3 such that no intervening devices, such as a circulator, water load, or tuner, are required.

To contain the heat generated within the microwave cavity during microwave thermal processing, the inside walls on the metallic structure 1 are lined with microwave transparent thermal insulation 5 to define a controlled atmosphere 7. A microwave transparent shelf 6 rests on top of the microwave transparent insulation 5. A microwave transparent and thermally insulated vessel 8 sits on top of the microwave transparent shelf 6 and holds the granular susceptor material 9.

Parts 10 are embedded within the granular susceptor material 9 for microwave thermal processing. Multiple parts 10, as shown in FIG. 1, or a single part can be embedded in the granular susceptor material 9 during microwave thermal processing. The parts 10 can comprise ceramic or metallic particulate material that is held together with a binder. The primary function of the granular susceptor material 9 is the equalization of the internal and external heating profiles of the parts 10 during microwave thermal processing. A secondary function of the granular susceptor material 9 is to provide support for the parts 10 during microwave thermal processing. A tertiary function of the granular susceptor material 9 is to provide a large microwave absorbing load that promotes non-resonant operation during microwave thermal processing. One aspect of the non-resonant operation is that the absorption of microwave energy by the granular susceptor material 9 inhibits reflection of the microwave radiation from the microwave cavity back into the waveguides 2, 3.

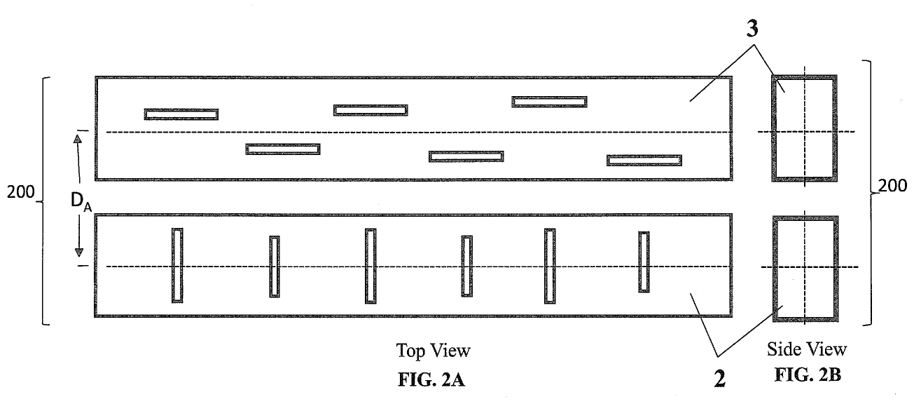

Referring now to the top view provided in FIG. 2A, the example embodiment includes a non-resonant, cross polarized slotted waveguide array 200 that contains a slotted waveguide 2 with transverse slots and a slotted waveguide 3 with longitudinal slots separated by a distance of D_{A} measured from the centerline of each of the slotted waveguides. The distance D_{A} is at least greater than one-half a wavelength of the microwave radiation. Looking at the side view, of FIG. 2B, the slotted waveguides 2 and 3 preferably have coplanar radiating surfaces. Linear and angular positional deviations of the waveguides 2 and 3 and the slots on those waveguides are within the example embodiments of the present disclosure. The slots in the waveguides are “cross polarized” meaning they are orthogonal or approximately orthogonal in orientation relative to each other.

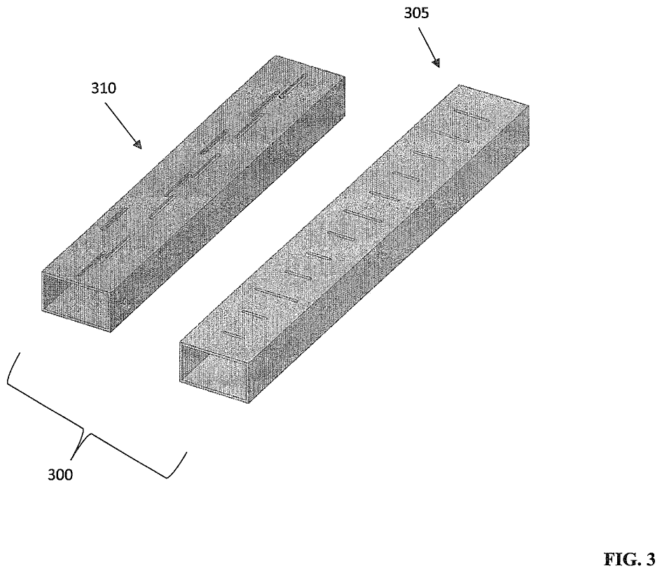

Referring now to FIG. 3, the image shows a three dimensional model of a non-resonant, cross polarized waveguide array 300 in accordance with the example embodiments of the present disclosure. The number, size and location of the slots in each of the waveguides of the array are calculated and manipulated to cause the waveguide array to radiate microwave energy in an evenly distributed, homogenous microwave radiation pattern. The three dimensional model of the waveguide with longitudinal slots shown to the left in the image contains 10 slots and the three dimensional model of the waveguide with transverse slots shown to right in the image contains 12 slots. The number of slots in the each of the waveguides do not need to match to achieve the desired performance. Typical dimensions of the waveguides as illustrated in FIG. 3 include a waveguide wall thickness of 3 mm, a waveguide height of 43 mm, and a waveguide width of 86 mm. The waveguides can be made of various metallic materials including copper and stainless steel.

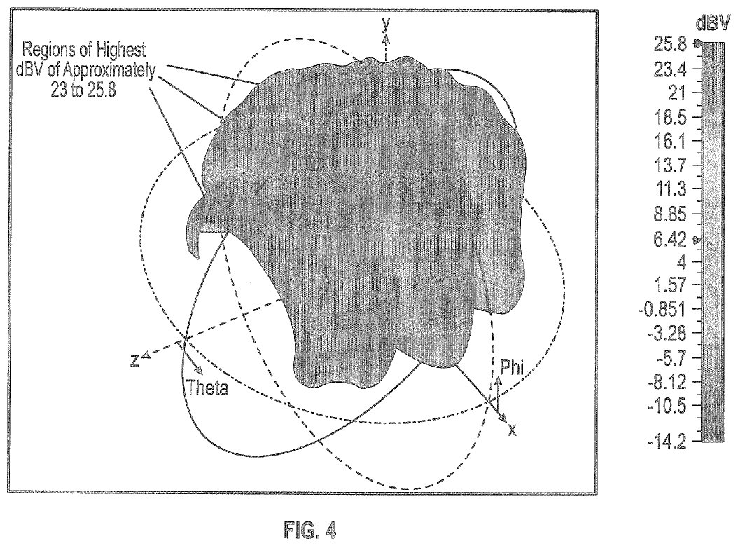

Referring now to FIG. 4, the image shows the three dimensional far-field microwave radiation distribution pattern, in spherical coordinates, for a non-resonant, cross polarized, slotted wave guide array of the example embodiments described herein. The far-field microwave radiation distribution pattern results from the combination of the microwave radiation emitted from the non-resonant, cross polarized waveguide array shown in FIG. 3. The far-field microwave radiation distribution pattern shown in FIG. 4 is for 2.45 GHz and is measured at a distance from 2 wavelengths to 6 wavelengths from the radiating surfaces of the waveguides.

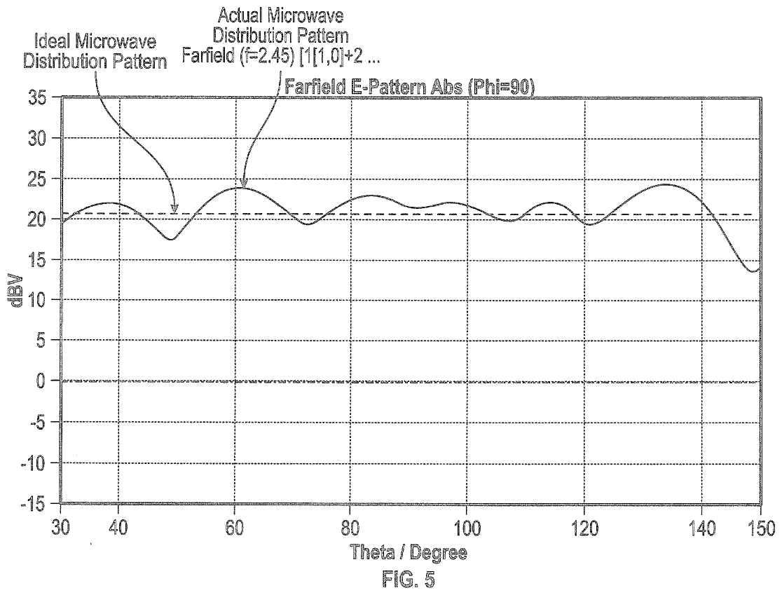

Referring now to FIG. 5, the image shows a plot of the Farfield Array Factor, in spherical coordinates, at a constant Phi of 90 degrees, for the waveguide array shown in FIG. 3. The angles Phi and Theta are defined in FIG. 4. The ideal microwave distribution pattern for microwave thermal processing is the average maximum power of the microwave radiation. In the example illustrated in FIG. 5, the ideal microwave distribution pattern is represented by the straight line shown in the Array Factor plot. The actual microwave distribution pattern from the non-resonant, cross polarized waveguide array from FIG. 3 shows a deviation from the ideal microwave distribution within a tolerance band of +/−7.5 dBV.

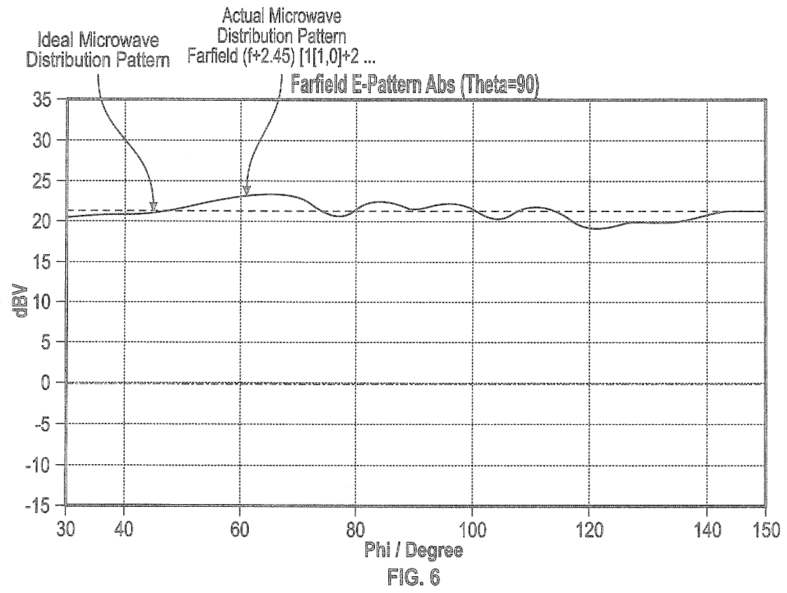

Referring now to FIG. 6, the image shows a plot of the Farfield Array Factor in spherical coordinates at a constant Theta of 90 degrees, for the waveguide array shown in FIG. 3. The ideal microwave distribution pattern for microwave thermal processing is represented by the straight line shown in the Array Factor plot. The actual microwave distribution pattern from the non-resonant, cross polarized waveguide array from FIG. 3 shows a deviation from the ideal microwave distribution within a tolerance band of +/−7.5 dBV. The relatively small deviations illustrated in FIG. 5 and FIG. 6 indicate the slots of the waveguide array have been configured to provide a generally uniform microwave distribution at the Farfield distance.

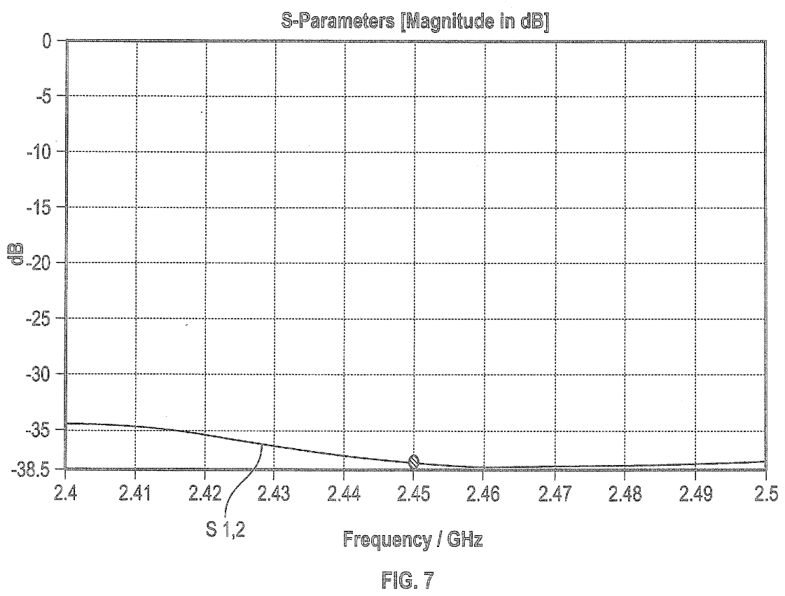

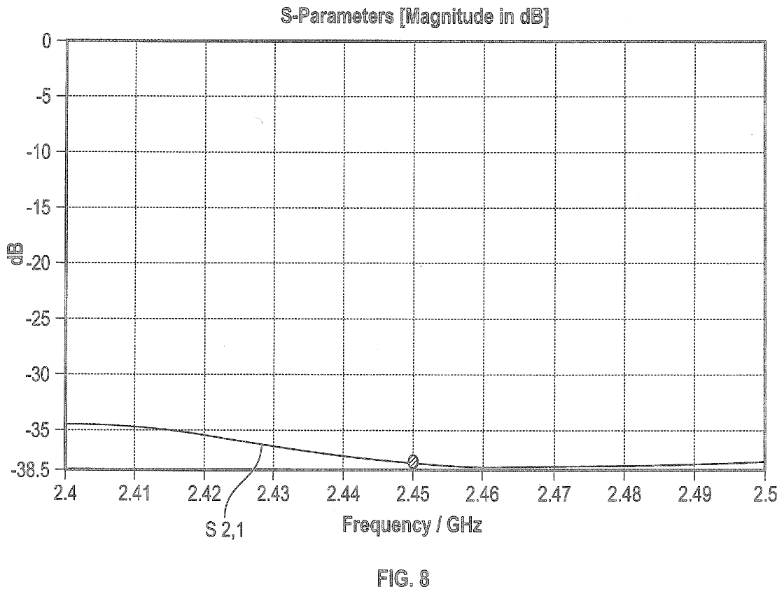

Referring now to FIG. 7 and FIG. 8, these two graphs show plots for the values of the S1,2 and S2,1 parameters, which are the scattering parameters used to measure the amount of cross-coupling between the waveguides. Cross coupling represents the amount of energy that is absorbed by waveguides that are positioned close to each other and it can be measured by calculating the S parameter values of the waveguides. A large amount of cross coupling between waveguides results in a microwave heating system of low efficiency with poor operational performance. For the waveguide array shown in FIG. 3, the values for the S-Parameters S1,2 and S2,1 approach −38.5 dB, which indicates a negligible amount of cross coupling resulting in the efficient performance of the waveguide array.

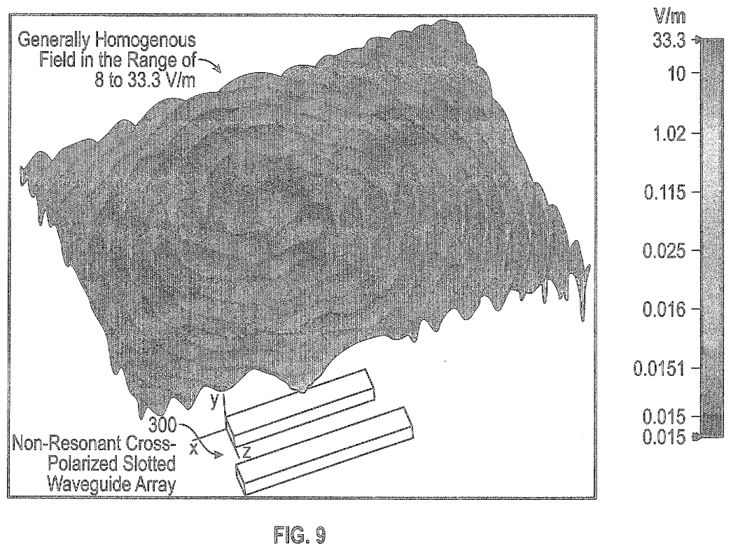

Referring now to FIG. 9, the image shows a three dimensional plot of the cross section of the Farfield electric field at a distance of four wavelengths from the radiating surface of the non-resonant, cross polarized slotted waveguide array shown in FIG. 3. The resulting electric field cross section is approximately 1,700 mm by 1,300 mm and exhibits a homogenous microwave distribution pattern.

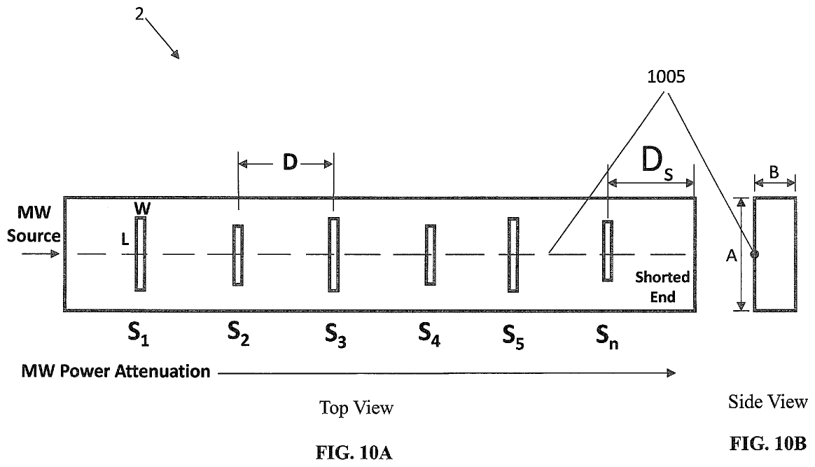

Referring now to FIGS. 10A and 10B, the images show a non-resonant slotted waveguide 2 with transverse slots and the variables that are used to achieve a homogenous microwave distribution pattern. Waveguide 2 is a simplified version of waveguide 305 of FIG. 3 for the purposes of illustration. The variables are listed and identified below:
A=Broad side of the waveguide
B=Narrow side of the waveguide
L=Length of the slot
W=Width of the slot
D=Distance between slots
Ds=Distance to shorted end of waveguide
Sn=Slot number for the nth slot
N=Total Number of Slots

As illustrated in FIGS. 10A and 10B, the slots have a length L that is greater than their width W and the length of each slot is transverse to a first major waveguide axis 1005 (i.e., the centerline) passing through the center of the radiating surface of waveguide 2 along its length. The transverse slots are centered on the first major waveguide axis 1005, and their length depends on the resistance of the slot. The resulting pattern of transverse slots, positioned centered on the first major waveguide axis 1005, inhibits the creation of standing waves within the waveguide.

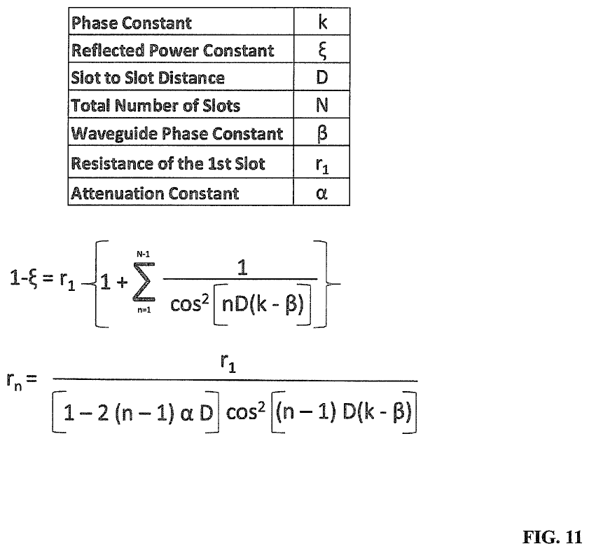

Referring to FIG. 11, shown are the equation and the variables used to calculate the far-field resistance value of the n-th slot for a non-resonant slotted waveguide with transverse slots.

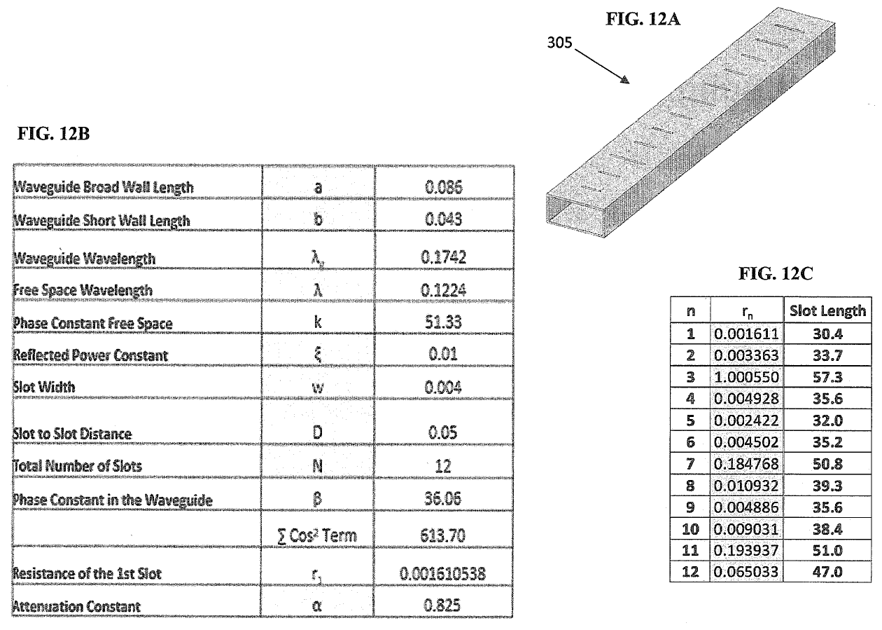

Referring to FIG. 12A, the image shows a three dimensional model of the non-resonant slotted waveguide with transverse slots 305 used by the example embodiment. FIG. 12B shows the values of the variables associated with the example non-resonant slotted waveguide 305. Lastly, FIG. 12C is a table containing the values for the slot resistance which are calculated from the equation shown in FIG. 11. The table in FIG. 12C also shows the slot lengths corresponding to the calculated resistance values. A person of skill in the art would be able to determine the slot lengths from the calculated resistance values. The three dimensional model of the slotted waveguide with transverse slots 305 shown in FIG. 12A is also shown as part of the non-resonant, cross polarized slotted waveguide array shown in FIG. 3.

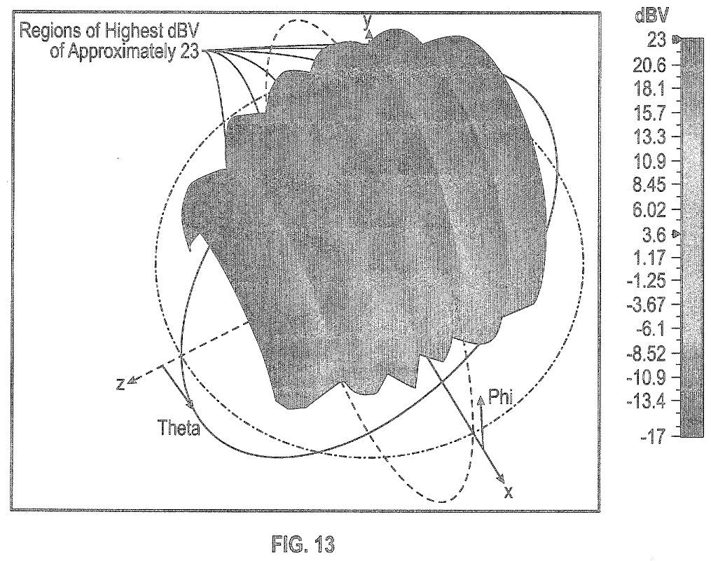

Referring now to FIG. 13, the image shows the three dimensional far-field microwave radiation distribution pattern, in spherical coordinates, for the non-resonant slotted wave guide with transverse slots 305 that is shown in FIG. 12.

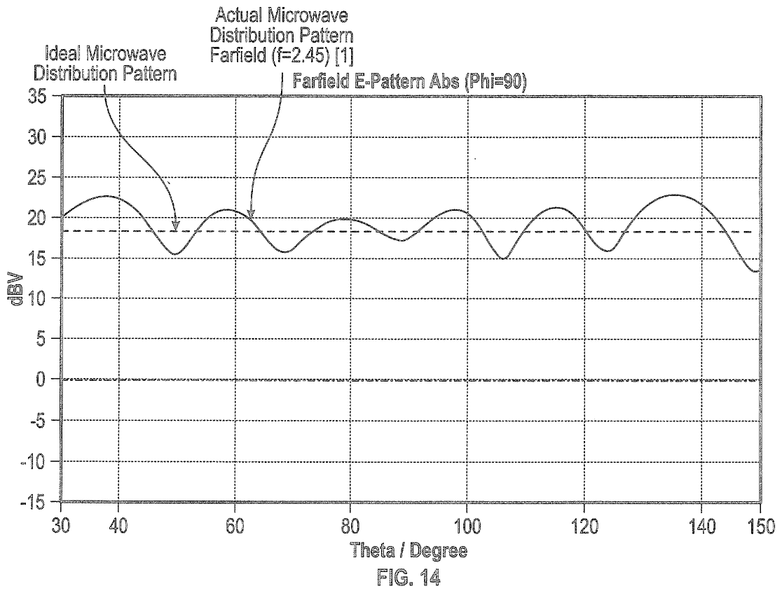

Referring now to FIG. 14, the image shows a plot of the far-field Array Factor, in spherical coordinate, at a constant Phi of 90 degrees, for the slotted waveguide with transverse slots shown in FIG. 12. Similar to the previous explanation in connection with FIGS. 4-6, Phi and Theta are defined in FIG. 13. Likewise, the ideal microwave distribution pattern for microwave thermal processing is the average maximum power of the microwave radiation represented by the straight line shown in the Array Factor plot. The actual microwave distribution pattern from the slotted waveguide with transverse slots from FIG. 11 shows a deviation from the ideal microwave distribution within a tolerance band of +/−7.5 dBV.

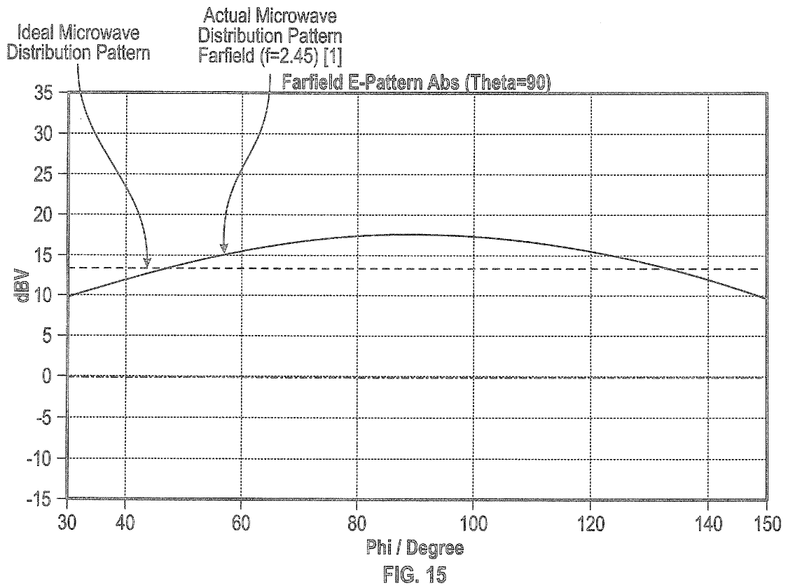

Referring now to FIG. 15, the image shows a plot of the far-field Array Factor, in spherical coordinate, at a constant Theta of 90 degrees, for the slotted waveguide with transverse slots shown in FIG. 12. The ideal microwave distribution pattern for microwave thermal processing is represented by the straight line shown in the Array Factor plot. The actual microwave distribution pattern from the slotted waveguide with transverse slots from FIG. 11 shows a deviation from the ideal microwave distribution within a tolerance band of +/−7.5 dBV.

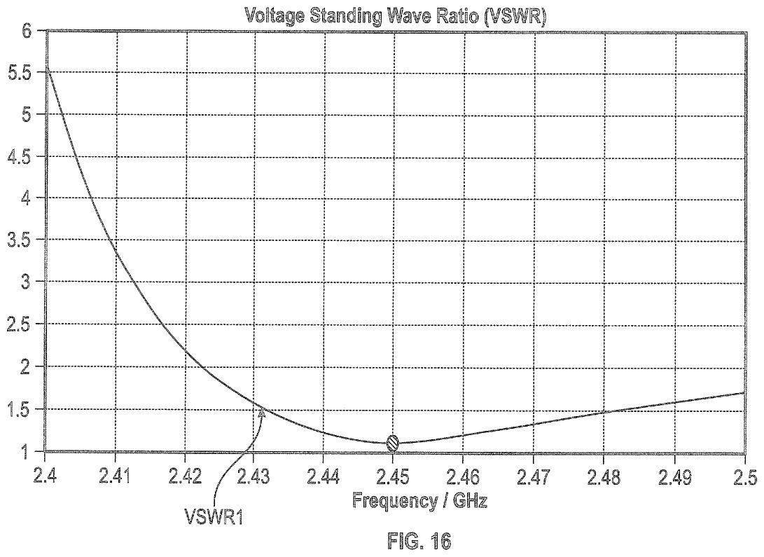

Referring now to FIG. 16, the image shows a plot of Voltage Standing Wave Ratio (VSWR) for the slotted waveguide with transverse slots 305 shown in FIG. 12. The minimum VSWR value is one, which in this case means that no power is being reflected back to the magnetron that is directly mounted on the slotted waveguide. For the slotted waveguide with transverse slots 305 shown FIG. 12, the VSWR value is approximately 1.2, which represents a negligible amount of energy being reflected back to the magnetrons, resulting in the efficient distribution of microwave energy.

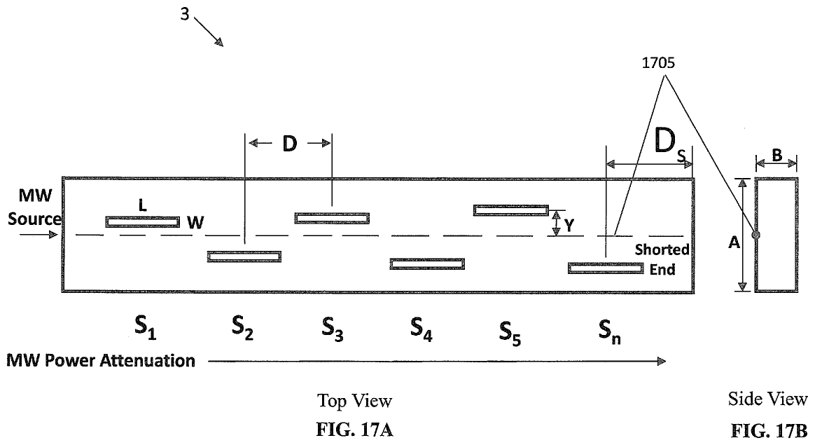

Referring now to FIGS. 17A and 17B, The image shows a non-resonant slotted waveguide 2 with longitudinal slots and the variables that are used to achieve a homogenous microwave distribution pattern. Waveguide 3 is a simplified version of waveguide 310 of FIG. 3 for the purposes of illustration. The variables are listed and identified below:
A=Broad side of the waveguide
B=Narrow side of the waveguide
L=Length of the slot
W=Width of the slot
D=Distance between slots
Ds=Distance to shorted end of waveguide
Sn=Slot number for the nth slot
N=Total Number of Slots
Y=Offset slot distance from the center of the waveguide to the center of the slot

As illustrated in FIG. 17A, the slots have a length L that is greater than their width W and the length of each slot is parallel to a second major waveguide axis 1705 (i.e., the centerline) passing through the center of the radiating surface of waveguide 3 along its length. The longitudinal slots are at varying offset distances Y from the second major waveguide axis 1705 and the offset distances of the slots are dependent on the conductance of the slots. The resulting pattern of longitudinal slots parallel to the second major waveguide axis 1705 inhibits the creation of standing waves within the waveguide.

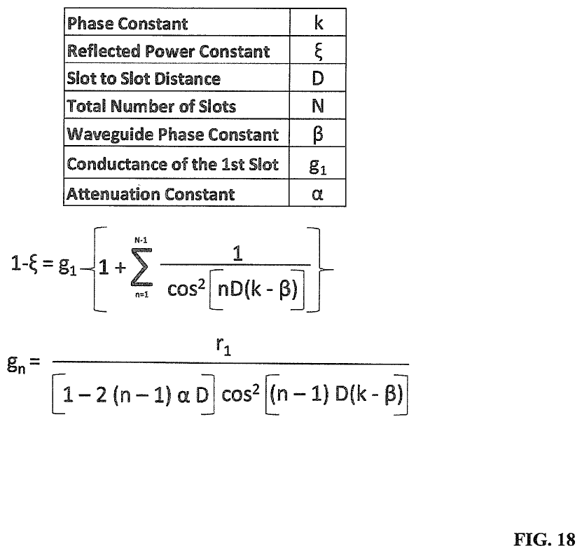

Referring to FIG. 18, shown are the equation and the variables used to calculate the far-field conductance value of the n-th slot for a non-resonant slotted waveguide with longitudinal slots.

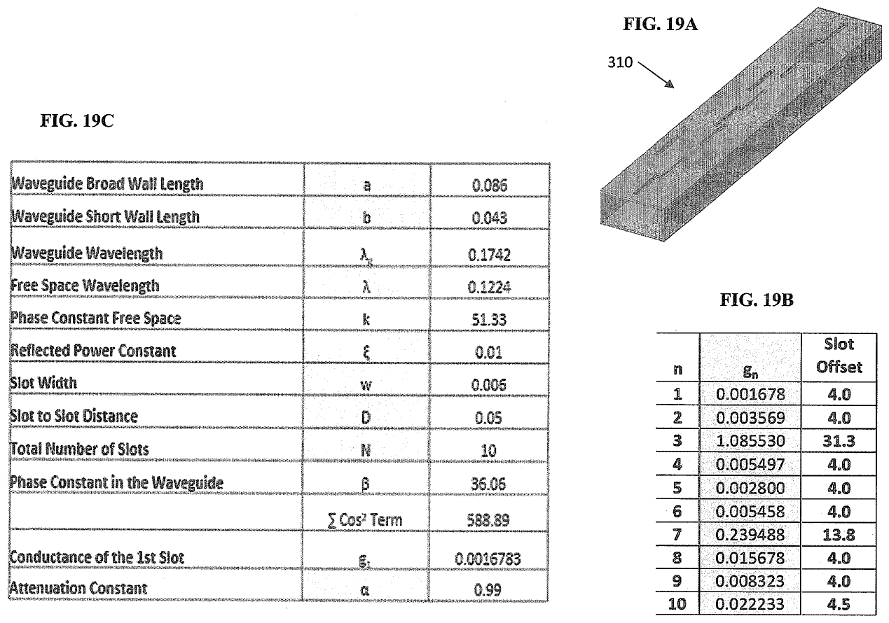

Referring to FIG. 19A, the image shows a three dimensional model of the non-resonant slotted waveguide with longitudinal slots 310 used by the example embodiment. FIG. 19B shows the values of the variables associated with the example non-resonant slotted waveguide 305. Lastly, FIG. 19C shows a table containing the values for the slot conductance which are calculated from the equation shown in FIG. 18. The table of FIG. 19C also shows the offset distances of the longitudinal slots from the second major waveguide axis 1705 corresponding to the calculated conductance values. The three dimensional model of the slotted waveguide with transverse slots shown in FIG. 19A is also shown as part of the non-resonant, cross polarized slotted waveguide array shown in FIG. 3

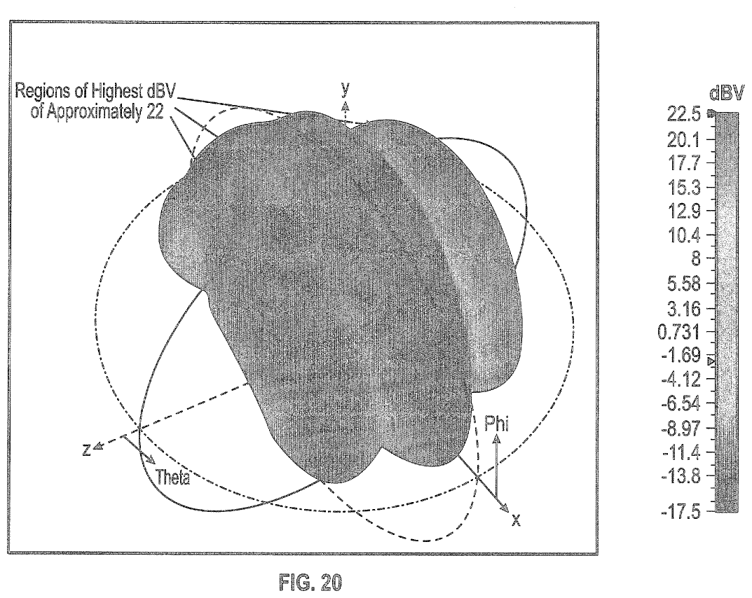

Referring now to FIG. 20, the image shows the three dimensional far-field microwave radiation distribution pattern, in spherical coordinates, for the non-resonant slotted wave guide with longitudinal slots that is shown in FIG. 19A.

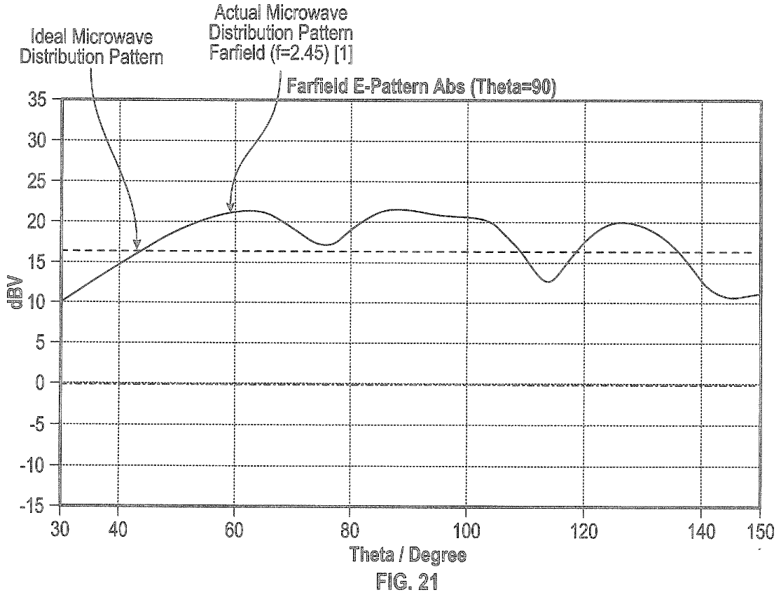

Referring now to FIG. 21, the image shows a plot of the far-field Array Factor, in spherical coordinates, at a constant Phi of 90 degrees, for the slotted waveguide with longitudinal slots shown in FIG. 19A. Similar to the previously described figures, Phi and Theta are defined in FIG. 20. The ideal microwave distribution pattern for microwave thermal processing is the average maximum power of the microwave radiation represented by the straight line shown in the Array Factor plot. The actual microwave distribution pattern from the slotted waveguide with longitudinal slots from FIG. 19A shows a deviation from the ideal microwave distribution within a tolerance band of +/−7.5 dBV.

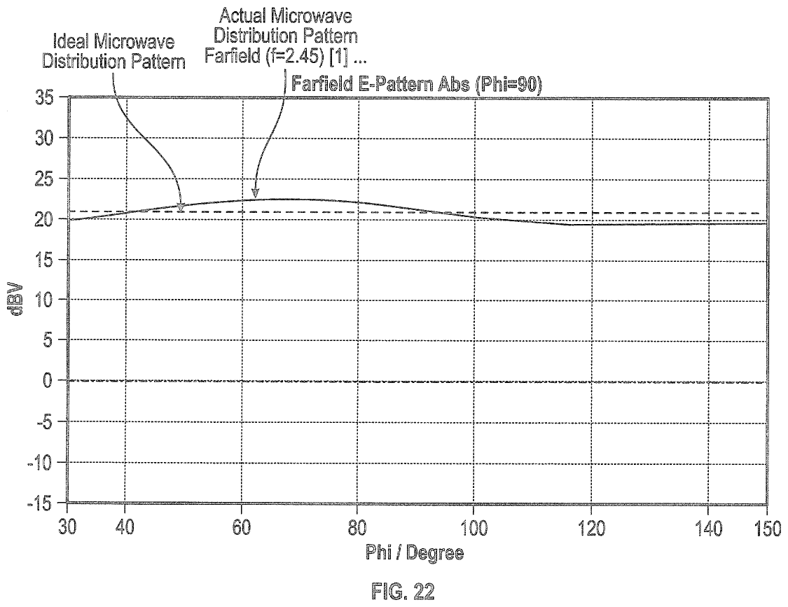

Referring now to FIG. 22, the image shows a plot of the far-field Array Factor, in spherical coordinates, at a constant Theta of 90 degrees, for the slotted waveguide with longitudinal slots shown in FIG. 19A. The ideal microwave distribution pattern for microwave thermal processing is represented by the straight line shown in the Array Factor plot. The actual microwave distribution pattern from the slotted waveguide with longitudinal slots from FIG. 19A shows a deviation from the ideal microwave distribution within a tolerance band of +/−7.5 dBV.

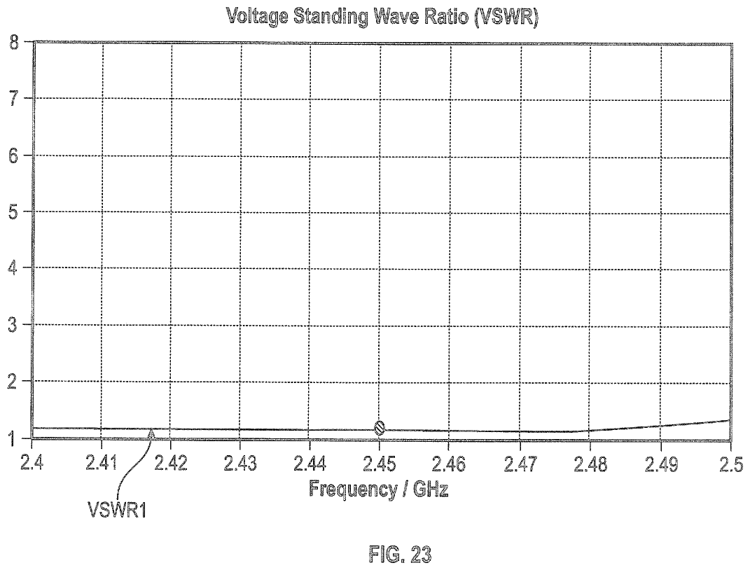

Referring now to FIG. 23, the image shows a plot of Voltage Standing Wave Ratio (VSWR) for the slotted waveguide with longitudinal slots shown in FIG. 19A. The minimum VSWR value is one, which in this case means that no power is being reflected back to the magnetron that is directly mounted on the slotted waveguide. For the slotted waveguide with longitudinal slots shown FIG. 19A, the VSWR value is approximately 1.3, which represents a negligible amount of energy being reflected back to the magnetrons, resulting in the efficient distribution of microwave energy.

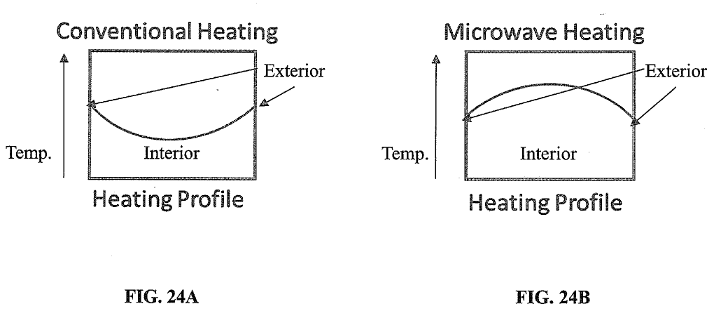

Referring now to FIGS. 24A and 24B, the images show the cross-sectional heating profiles of a part heated using conventional heating and a part heated using microwave heating where the part is made from metallic and/or ceramic particulates. For conventional heating, the outside of the part is at higher temperature than the inside of the part. This is due to the heat transfer mechanism of conventional heating where heat is transferred from the hot furnace environment into the part. In contrast, for microwave heating, the inside of the part is hotter than the outside of the part. The microwave heating mechanism is primarily one of energy conversion rather than energy transfer. The individual metallic or ceramic particles that make up a part directly absorb and convert the microwave energy into heat, which results in volumetric heating. This heating mechanism rapidly heats up the entire part simultaneously. Since only the part is being heated, the cooler environment around the part causes cooling on the outer surfaces of the part, which in turn results in the reverse heating profile shown in FIG. 24B

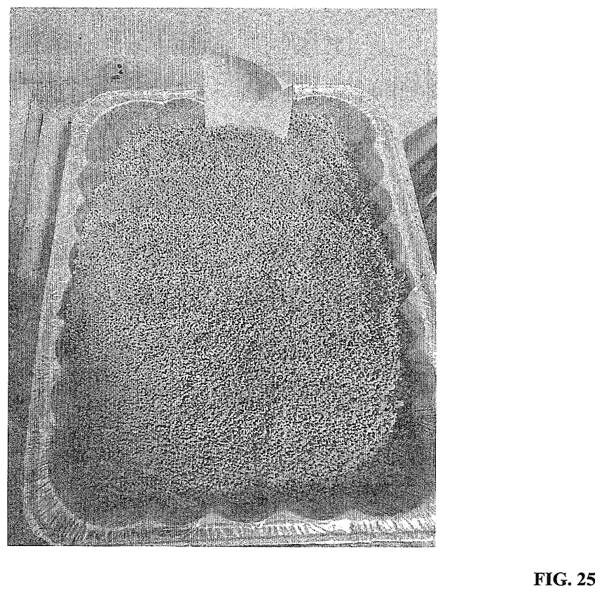

Referring now to FIG. 25, the image shows a sample of granular susceptor material in accordance with the example embodiments of the present disclosure. In certain example embodiments, the granular susceptor material is composed of a major amount of a ceramic material, a minor amount of a microwave absorbing material, a binder material, and a ceramic pigment. The ceramic material is an oxide ceramic such as Alumina, Zirconia and Thoria. Suitable microwave absorbing materials include carbon, silicon carbide, molybdenum disulfide and any metal in powder form. The binder material is a powdered clay. Optionally, a ceramic pigment may be added to color code the granular susceptor material to distinguish it from the particulate material of the part that is being sintered. The materials are mixed and agglomerated into susceptor material granules ranging in size from 0.5 mm to 10 mm. After agglomeration, the susceptor material granules are dried and fired.

The proportions of the components of the granular susceptor material can vary. Examples of component formulations for the granular susceptor material are as follows:

### Example 1

50% to 90% oxide ceramic;
5% to 15% microwave absorbing material;
5% to 20% susceptor material binder; and
5% to 20% water.

### Example 2

50% to 90% alumina hydrate;
5% to 15% silicon carbide powder;
5% to 20% kaolin clay powder; and
5% to 20% water.

### Example 3

3000 grams of alumina hydrate (fine powder)
300 grams of silicon carbide powder (44 micron)
500 grams of kaolin clay powder (fine powder)
550 grams of water

In examples 2 and 3 above, silicon carbide powder can be replaced with stainless steel 316 powder having a particle size of 25 microns.

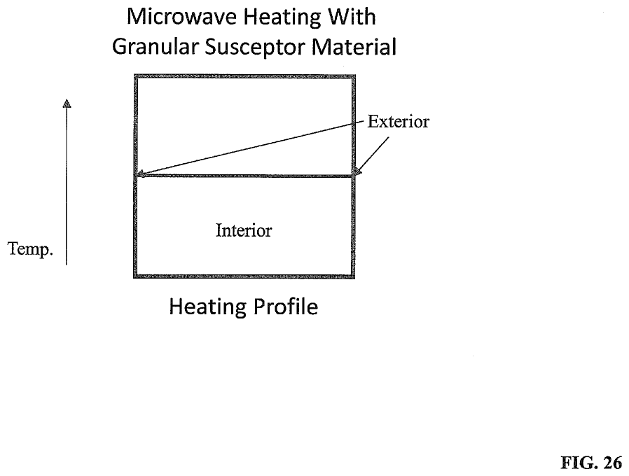

Referring now to FIG. 26, the image shows the part heating profile for microwave heating with the granular susceptor material of the example embodiments described herein. In contrast to the microwave heating example of FIG. 24B where no granular susceptor material was used, FIG. 26 illustrates an example of microwave heating where the part is embedded in the example granular susceptor material. In the heating profile of FIG. 26, the internal and external temperatures of the part are approximately equal. This is accomplished by embedding the part in the granular susceptor material during microwave thermal processing. The granular susceptor material causes more uniform heating of the part.

The particle size and the amount of the microwave absorbing material in the granular susceptor material are chosen such that the heating rate of the granular susceptor material closely matches the heating rate of the part or parts being processed. The part to be sintered is composed of particulate material have a first heating rate, also referred to as the particulate material heating rate, and the granular susceptor material has a second heating rate, also referred to as the susceptor material heating rate. In one example, the susceptor material heating rate differs from the particulate material heating rate by an amount in the range of 0% to 10% where 0% indicates there is no difference between the susceptor material heating rate and the particulate material heating rate. In another example, the susceptor material heating rate differs from the particulate material heating rate by an amount in the range of 0% to 5%, and in yet another example, the two heating rates differ by an amount in the range of 0% to 2%.

In certain example embodiments, the microwave absorbing material is selected to be of the same type of material as the particulate material used to form the part that is to be sintered. For instance, if the particulate material of the part is a particular metal, the same metal will be selected for the microwave absorbing material of the granular susceptor material. Selecting the same type of material ensures that the heating rate of the granular susceptor material will be similar to the heating rate of the part thereby providing uniform heating of the part.

During sintering of the part embedded in the granular susceptor material with microwave energy, the temperature of the part can be monitored in one or more of a variety of approaches. In one example, the temperature of the part can be monitored indirectly by measuring the temperature of a thermocouple inserted into the granular susceptor material. In another example, the temperature of the part can be monitored indirectly with a pyrometer that has a direct line of sight to the granular susceptor material. In yet another example, the temperature of the part can be monitored directly with a pyrometer that has a direct line of sight to a surrogate part embedded in the granular susceptor material.

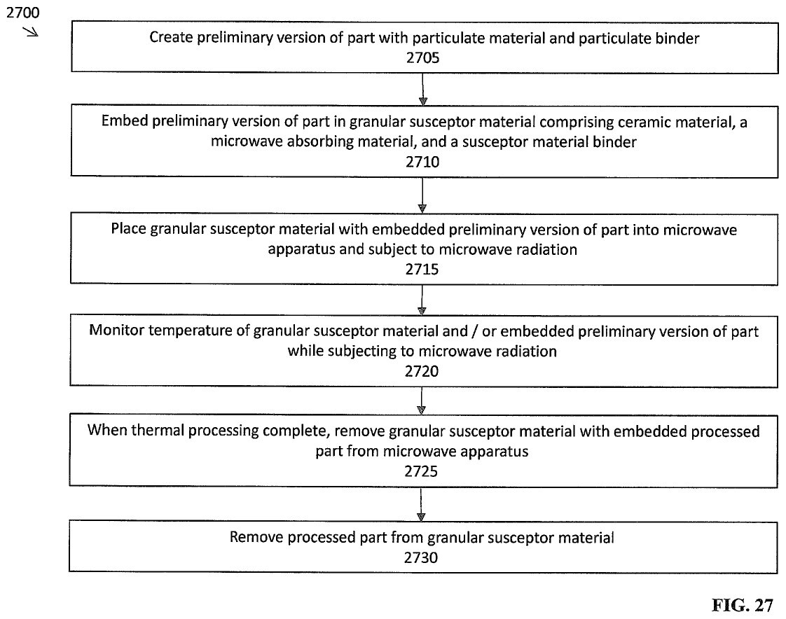

Referring now to FIG. 27, an example method 2700 is illustrated in accordance with the embodiments of this disclosure. Example method 2700 comprises operations for thermal processing of a part using the example microwave apparatus and the example granular susceptor material described herein. In alternate embodiments, certain steps of the method 2700 may be performed in parallel, in a different order, or may be eliminated and other steps may be added to the example method.

Referring to example method 2700, in step 2705, a preliminary version of a part is created using a particulate material, such as particulate metal or ceramic, and a particulate binder. The preliminary version of the part can be formed using a mold or using an additive manufacturing process. In step 2710, the preliminary version of the part is embedded in a granular susceptor material. The granular susceptor material can be one of the example embodiments described herein and can include a ceramic material, a microwave absorbing material, and a susceptor material binder. In one example, the microwave absorbing material and the particulate material of the part can be made of the same type of material or of materials having similar heating rates.

In step 2715, the granular susceptor material with the embedded preliminary version of the part is placed into a microwave apparatus. As one example, the arrangement can be similar to the arrangement illustrated in the example of FIG. 1. The microwave apparatus can include an array of slotted waveguides consistent with the example embodiments described herein. Once arranged inside the microwave apparatus, the granular susceptor material with the embedded preliminary version of the part is subjected to microwave radiation in a thermal process. As illustrated in step 2720, during the thermal process, one or more thermal sensing devices, such as a thermocouple or pyrometer, can be used to monitor the temperature of the granular susceptor material and/or the embedded preliminary version of part.

The thermal process transforms the preliminary version of the part into a processed part, which may or may not be the final state for the part. As illustrated in step 2725, when the thermal processing is complete, the granular susceptor material with the embedded processed part is removed from the microwave apparatus. Lastly, in step 2730, the processed part is removed from the granular susceptor material.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Similarly, for any apparatus shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Referring generally to the examples herein, any components of the microwave apparatus described herein can be made from a single piece (e.g., as from a mold, injection mold, die cast, 3-D printing process, extrusion process, stamping process, or other prototype methods). In addition, or in the alternative, a component of the apparatus can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to couplings that are fixed, hinged, removeable, slidable, and threaded.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Although example embodiments are described herein, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A microwave apparatus for thermally processing particles, the microwave apparatus comprising:
a metallic housing;
a first microwave energy source positioned to direct first microwave radiation into a first slotted waveguide, the first slotted waveguide comprising a first major waveguide axis and a plurality of longitudinal slots that emit a first modified microwave radiation, wherein the plurality of longitudinal slots have a length that is parallel to the first major waveguide axis; and
a second microwave energy source positioned to direct second microwave radiation into a second slotted waveguide, the second slotted waveguide comprising a second major waveguide axis and a plurality of transverse slots that emit a second modified microwave radiation, wherein the plurality of transverse slots have a length that is perpendicular to the second major waveguide axis.

2. The microwave apparatus of claim 1, wherein
the first major waveguide axis passes through a first longitudinal center of a first radiating surface of the first slotted waveguide;
the second major waveguide axis passes through a second longitudinal center of a second radiating surface of the second slotted waveguide; and
the first major waveguide axis and the second major waveguide axis are parallel.

3. The microwave apparatus of claim 2, wherein the first major waveguide axis and the second major waveguide axis are separated by a distance greater than a half wavelength of the first microwave radiation.

4. The microwave apparatus of claim 1, wherein the first slotted waveguide has an S11 parameter value less than −20 dB and greater than −40 dB.

5. The microwave apparatus of claim 1, wherein the first slotted waveguide has a voltage standing wave ratio parameter value less than 1.5 and greater than 1.

6. The microwave apparatus of claim 1, wherein for the first slotted waveguide, a graph of the first modified microwave radiation in spherical coordinates at a constant value of Phi =90 has a maximum deviation of +/−7.5 dBV in a range from 30 degrees to 150 degrees.

7. The microwave apparatus of claim 1, wherein for the first slotted waveguide, a graph of the first modified microwave radiation in spherical coordinates at a constant value of Theta=90 has a maximum deviation of +/−7.5 dBV in a range from 30 degrees to 150 degrees.

8. The microwave apparatus of claim 1, wherein the second slotted waveguide has an S11 parameter value less than −20 dB and greater than −40 dB.

9. The microwave apparatus of claim 1, wherein the second slotted waveguide has a voltage standing wave ratio parameter value less than 1.5 and greater than 1.

10. The microwave apparatus of claim 1, wherein for the second slotted waveguide, a graph of the second modified microwave radiation in spherical coordinates at a constant value of Phi=90 has a maximum deviation of +/−7.5 dBV in a range from 30 degrees to 150 degrees.

11. The microwave apparatus of claim 1, wherein for the second slotted waveguide, a graph of the second modified microwave radiation in spherical coordinates at a constant value of Theta=90 has a maximum deviation of +/−7.5 dBV in a range from 30 degrees to 150 degrees.

12. The microwave apparatus of claim 1, wherein for a combined electric field of the first modified microwave radiation and the second modified microwave radiation, a graph in spherical coordinates at a constant value of Phi=90 has a maximum deviation of +/−7.5 dBV in a range from 30 degrees to 150 degrees.

13. The microwave apparatus of claim 1, wherein for a combined electric field of the first modified microwave radiation and the second modified microwave radiation, a graph in spherical coordinates at a constant value of Theta=90 has a maximum deviation of +/−7.5 dBV in a range from 30 degrees to 150 degrees.

14. The microwave apparatus of claim 1, wherein the first slotted waveguide and the second slotted waveguide have an S21 parameter value less than −20 dB and greater than −40 dB.

15. The microwave apparatus of claim 1, wherein the first slotted waveguide and the second slotted waveguide have an S12 parameter value less than −20 dB and greater than −40 dB.

16. The microwave apparatus of claim 1, wherein the first microwave energy source is directly coupled to the first slotted waveguide and the second microwave energy source is directly coupled to the second slotted waveguide.

17. The microwave apparatus of claim 1, wherein a majority of transverse slots of the plurality of transverse slots have unique lengths relative to the second major waveguide axis of the second slotted waveguide.

18. The microwave apparatus of claim 1, further comprising a granular susceptor material, the granular susceptor material comprising a ceramic material, a microwave absorbing material, and a susceptor material binder.

19. A process for thermally processing a particulate material to form a processed part, the process comprising:
creating a preliminary version of a part, the preliminary version of the part comprising the particulate material and a particulate binder;
embedding the preliminary version of the part in a granular susceptor material, the granular susceptor material comprising a ceramic material, a microwave absorbing material, and a susceptor material binder; and
subjecting the preliminary version of the part submerged in the granular susceptor material to microwave radiation from a microwave apparatus to form the processed part,
wherein the microwave apparatus comprises:
a first slotted waveguide comprising a plurality of longitudinal slots and a second slotted waveguide comprising a plurality of transverse slots.

20. The process of claim 19, wherein
a majority of longitudinal slots of the plurality of longitudinal slots have unique offset distances from a first major waveguide axis of the first slotted waveguide; and
a majority of transverse slots of the plurality of transverse slots have unique lengths relative to a second major waveguide axis of the second slotted waveguide.
